(19) United States
(12) Patent Application Publication
(10) Pub. No.: US 2015/0319754 A1
(43) Pub. Date: Nov. 5, 2015

(54) WIRELESS COMMUNICATION METHOD AND WIRELESS COMMUNICATION SYSTEM

(71) Applicant: HITACHI, LTD., Tokyo (JP)

(72) Inventors: Hitoshi ISHIDA, Tokyo (JP); Tomonori YAMAMOTO, Tokyo (JP); Satoshi TAMAKI, Tokyo (JP); Tsuyoshi TAMAKI, Tokyo (JP)

(21) Appl. No.: 14/648,883

(22) PCT Filed: Jan. 16, 2013
(86) PCT No.: PCT/JP2013/050619

§ 371 Date: Jun. 1, 2015

(51) Int. Cl. H04W 72/04; H04W 16/32; H04W 74/00

(52) U.S. Cl. CPC H04W 72/0426; H04W 74/002; H04W 16/32; H04W 88/02

(57) ABSTRACT

When a carrier aggregation using a macro cell of a legacy carrier as a primary cell and using a small cell of a new carrier type as a secondary cell is performed, transmission of a control channel (PUCCH) of an uplink is concentrated on an uplink of the macro cell and frequency efficiency is degraded. For this reason, in a state in which the macro cell is configured as the primary cell, a serving cell transmitting the PUCCH is configured to a terminal and the terminal transmits the PUCCH using the configured serving cell.

### TECHNICAL FIELD

The present invention relates to a base station performing communication using a plurality of frequency carriers and a wireless communication system.

### BACKGROUND ART

Recently, development of smart phones or tablet terminals has stimulated concern over a wireless traffic amount increasing explosively. In order to take wireless traffic increasing in this way, it is necessary to improve a capacity of the wireless traffic (wireless communication capacity) that can be taken. As technology for improving the wireless communication capacity, a small cell configuration covering a service area by multiple low transmission power base stations (low power nodes (LPNs)) has attracted attention. In the long term evolution (LTE) standard, a base station may be called an E-UTRAN node B (eNB) and a terminal may be called a user equipment (UE).

The small cell is called a micro cell, a pico cell, or a femto cell and the base station covering the small cell is called a micro base station (micro eNB), a pico base station (pica eNB), or a femto base station (femto eNB). The femto base station may be called a Home eNB (HeNB). Meanwhile, a base station in which transmission power is large and a communication area is wide is called a macro base station (macro eNB) and a communication area of the macro base station is called a macro cell.

Generally, a size of a cell is decreased and multiple small cells are arranged, so that the wireless communication capacity can be increased. However, it is difficult to secure the entire coverage of the communication area by only the small cells. In addition, when the number of small cells increases, control information regarding movement management (mobility) of a terminal such as handover may also increase.

As one of network configurations to resolve such a problem, a network configuration illustrated in FIG. 1 is examined. In a network illustrated in FIG. 1, multiple small cell base stations 1-3 are arranged in a communication area (macro cell 1-2) of a macro base station 1-1 and multiple small cells 1-4 are formed. This network configuration is also called a heterogeneous network (HetNet). In FIG. 1, different frequencies are used in the macro cell 1-2 and the small cell 1-4. For example, it is assumed that a low frequency such as 2 GHz or 800 MHz is used in the macro cell 1-2 and a high frequency such as 3.5 GHz is used in the small cell 1-4.

A terminal 1-5 performs communication with one of the macro base station 1-1 and the small cell base station 1-3 or both the macro base station 1-1 and the small cell base station 1-3, according to a position or an electric wave situation. The macro base station 1-1 and the small cell base station 1-3 may be connected directly by an optical fiber or may be connected by a wireless backhaul. Alternatively, the macro base station and the small cell base station may be connected by a network.

In the macro cell 1-2, system information or control information for the handover is transmitted and received to secure the coverage and manage the mobility. This information may be called control-plane (C-plane) information. Meanwhile, in the small cell 1-4, information based on data is transmitted and received. This information may be called user-plane (U-plane) information. By using the network configuration described above, both the securing of the coverage and the control/management of the mobility and an effect of increasing the wireless communication capacity by the small cells can be realized.

To use a new frequency carrier called a new carrier type (NCT) in the small cell 1-4 of FIG. 1 has been examined in the standards body (3rd Generation partnership project (3GPP)) to raise the effect of increasing the wireless communication capacity by the small cells. The new carrier type is disclosed in NPL 1, for example.

FIG. 2 illustrates resource configurations of a frequency carrier (called a legacy carrier 2-1) and an NCT 2-2 according to the related art. FIG. 2 illustrates two continuous physical resource blocks (PRBs) of a downlink in the LTE standard, which are called a PRB pair. One PRB includes 12 subcarriers and 7 orthogonal frequency division multiplexing (OFDM) symbols. A resource occupied by one subcarrier of one OFDM symbol is called a resource element (RE). Time occupied by one PRB is 0.5 millisecond and is called a slot, and time occupied by PRB pair is 1 millisecond and is called a subframe.

In the legacy carrier 2-1, a physical downlink control channel (PDCCH) 2-3 is transmitted in a plurality of OFDM symbols of the first half of the PRB pair. The PDCCH is a channel to transmit scheduling information of a downlink and an uplink. In a certain PRB, a physical hybrid ARQ indicator channel (PHICH) or a physical control format indicator channel (PCFICH) not illustrated in the drawings may be transmitted in the same OFDM symbol as the PDCCH. The PHICH is a channel to transmit hybrid automatic repeat request (HARQ) acknowledgement (ACK) information for a physical uplink shared channel (PUSCH) to be a data channel of the uplink. The PCFICH is a channel to transmit the number of OFDM symbols of the PDCCH. These channels correspond to control channels of a downlink of a physical layer.

In addition, in the legacy carrier 2-1, cell-specific reference signals (CRSs) 2-4 corresponding to a plurality of antenna ports are distributed to the PRB pair and are inserted into the PRB pair. The CRS 2-4 is a reference signal used for demodulation or synchronization tracking of the control channel such as the PDCCH and measurement of reception power or channel state information (CSI) of each cell. The CRS 2-4 may be used for demodulation of a physical downlink shared channel (PDSCH) 2-6 to be a data channel of the downlink, according to a transmission mode. A demodulation RS (DMRS) 2-5 (also called a UE-specific RS) may be inserted as a reference signal for the demodulation of the PDSCH 2-6. In addition, a CSI-RS to be a reference signal for channel information measurement not illustrated in the drawings may be inserted periodically. In addition, a synchronization signal or a broadcast signal of the physical layer may be transmitted in the PRB with a certain subframe.

The RE other than the control channel and the reference signal described above is a resource that can be used for the PDSCH 2-6 to be the data channel of the downlink. That is, the control channel or the reference signal becomes overhead. From FIG. 2, it is known that the overhead is large in the legacy carrier 2-1.

Meanwhile, in the NCT 2-2, the PDCCH 2-3 is not transmitted. In addition, in the CRSs 2-4, only a signal corresponding to one antenna port is transmitted with a period of 5 subframes. In the NCT 2-2, the CRS 2-4 is used for synchronization tracking and is not used for demodulation of the control channel. In scheduling of the uplink or the downlink, a control channel called an enhanced PDCCH (EPDCCH) 2-7 is used. The EPDCCH 2-7 is demodulated using the DMRS 2-5 and is transmitted using the same area as the PDSCH. That is, in a certain PRB pair, the PDSCH 2-6 or the EPDCCH 2-7 is transmitted. A transmission mode in which the PDSCH 2-6 is demodulated using the CRS 2-4 is not supported and only a transmission mode in which the PDSCH 2-6 is demodulated using the DMRS 2-5 is supported. As a result, in the NCT 2-2, the PDCCH 2-3 or the CRS 2-4 can be reduced and the overhead can be reduced. The NCT 2-2 is defined for the downlink. However, the NCT 2-2 is not defined for the uplink. That is, the same resource structure as the legacy carrier may be taken for the uplink.

As described above, the NCT 2-2 can reduce the control channel or the reference signal. Meanwhile, the terminal and the base station cannot perform communication using only the NCT 2-2. For this reason, it is assumed that the NCT 2-2 is used at the same time as the legacy carrier 2-1. The simultaneous use of the plurality of frequency carriers is realized by technology called a carrier aggregation (CA). The CA is disclosed in NPL 2, for example. Here, one frequency carrier includes PRBs from 6 to 110 and a bandwidth thereof becomes 1.4 MHz to 20 MHz. The frequency carrier may also be called a component carrier (CC). Hereinafter, the frequency carrier is called the CC.

Even when a plurality of CCs are used by the CA, the terminal establishes one radio resource control (RRC) connection with the network. A cell in which the terminal establishes the connection is called a primary cell (PCell). Information (this information is called non-access stratum (NAS) information) regarding mobility control such as an ID of a tracking area or security information is provided in only the PCell. A CC of the downlink corresponding to the PCell is called a downlink primary CC (DL PCC) and a CC of the uplink is called an uplink PCC (UL PCC).

Meanwhile, cells corresponding to the DL CC and the UL CC other than the PCell are called secondary cells (SCells). The DL CC and the UL CC corresponding to the SCells are called a DL SCC and a UL SCC. However, the SCell may include only the DL CC.

Here, a cell in which the terminal transmits and receives a signal is called a serving cell. The PCell and the SCell are regarded as different serving cells. In addition, even in the same base station, a cell of a different CC is regarded as a different serving cell.

When the NCT and the legacy carrier are simultaneously used by the CA, the legacy carrier becomes the PCell and the NCT becomes the SCell. That is, in FIG. 1, the macro cell 1-2 becomes the PCell and the small cell 1-4 becomes the SCell. When the PCell is changed, a procedure of the handover (that is, a procedure of a change of a security key and random access) is necessary. Meanwhile, when the SCell is changed, added, or removed, the procedure of the handover is not necessary. Therefore, in the example of FIG. 1, the terminal 1-5 can use the small cell 1-4 as an additive radio resource without the handover while maintaining connection with the macro cell 1-4 having the wide coverage. In addition, in the small cell 1-4, because the NCT having the small overhead is used, frequency efficiency of the small cell can be further raised.

### CITATION LIST

### Non Patent Literature

NPL 1: 3GPP, “RP-122028, Updated WI proposal: New Carrier Type for LTE,” 2012/12, Ericsson

NPL 2: 3GPP, “Overall description; Stage 2(Release 11),” TS 36.300, V11.3.0, pp. 46-47, 57, 2012/09

NPL 3: 3GPP, “Physical Channels and Modulation (Release 11),” TS 36.211, V.11.1.0, 2012/12

NPL 4: 3GPP, “Radio Resource Control (RRC); Protocol specification (Release 11),” TS 36.311, V.11.2.0, 2012/12

### SUMMARY OF INVENTION

### Technical Problem

The HARQ ACK for the PDSCH to be the data channel of the downlink, the CSI to be the channel information of the downlink of each serving cell, or a scheduling request (SR) of the uplink are transmitted from the terminal to the base station using a physical uplink control channel (PUCCH) to be the control channel of the uplink. This information is control information of the uplink and is called uplink control information (UCI).

When the CA is used, the PUCCH is transmitted on only the PCell. For this reason, in the example of FIG. 1, in addition to the PUCCH of the terminal of the macro cell, a PUCCH of the terminal of the small cell is transmitted from each terminal to the macro base station, in the uplink (that is, the UL PCC) of the PCell.

This example is illustrated in FIG. 3. FIG. 3 illustrates an example of a frequency division duplex (FDD) system. It is assumed that the DL CC and the UL CC used by a macro base station 3-1 are F1DL and F1UL and the F1DL is the legacy carrier. It is assumed that the DL CC and the UL CC used by a small cell base station 3-3 are F2DL and F2UL and the F2DL is the NCT. Because a terminal 3-5 is positioned in only a coverage area (that is, a macro cell 3-2) of the macro base station 3-1, the terminal 3-5 performs communication with only the macro base station 3-1. Meanwhile, because a terminal 3-6 is positioned in areas of both the macro cell 3-2 and the small cell 3-4, the terminal 3-6 can perform communication with both the macro base station 3-1 and the small cell base station 3-3 using the CA.

At this time, for example, when the PDSCH is transmitted from the macro base station 3-1 to the terminal 3-5 by the F1DL, the HARQ-ACK for the PDSCH is transmitted from the terminal 3-5 to the macro base station 3-1, using the PUCCH on the F1UL. Meanwhile, when the PDSCH is transmitted from the small cell base station 3-3 to the terminal 3-6 by the F2DL, the HARQ-ACK for the PDSCH is also transmitted from the terminal 3-6 to the macro base station 3-1, using the PUCCH on the F1UL. In the case of the time division duplex (TDD), the DL CC and the UL CC become the same frequency carriers and the uplink and the downlink are distinguished by time. However, the TDD is basically the same as the FDD.

As described above, when the CA of the lagacy carrier and the NCT is performed, it is necessary to transmit the PUCCH using the UL CC of the lagacy carrier to be the PCell. As a result, when the multiple small cells 3-4 exist in the macro cell 3-2 in particular, it is necessary to transmit the PUCCH of all of the small cells 3-4 in the UL CC (F1UL) of the macro cell. For this reason, an amount of resources necessary for transmitting the PUCCH may increase and frequency efficiency of the uplink of the macro cell may be degraded. As a result, an amount of resources which the terminal 3-5 positioned at only the macro cell can use for the PUSCH may decrease and frequency efficiency of the terminal 3-5 may be degraded. A terminal (called a legacy terminal) of the old standard that cannot use the NCT and the UL CC corresponding to the NCT cannot use the UL CC (F2UL) of the small cell for transmitting the PUSCH and should transmit the PUSCH using the UL CC (F1UL) of the macro cell, even though the terminal is positioned in the area of the small cell. For this reason, similar to the terminal positioned at only the macro cell, an amount of resources usable for the PUSCH may decrease. In addition, because the terminal transmits the PUCCH to the macro cell base station, consumption power necessary for transmission increases as compared with the case in which the PUCCH is transmitted to the small cell base station. In order to simplify the description of the drawing, FIG. 3 illustrates the case in which the resources of the PUCCH occupy continuous frequency bands. However, the resources may occupy discontinuous frequency bands. For example, the resources may be over both ends of the bands, as described in NPL 3.

In the network configuration according to the related art in which the legacy carrier is used in the small cell base station 3-3, for the terminal positioned at the small cell 3-4, the small cell 3-4 can be configured as the PCell and the macro cell 3-2 can be configured as the SCell. That is, a CC different for each terminal can be configured as the PCell. For this reason, in an example of FIG. 3, the PUCCH of the terminal 3-6 can be transmitted to the small cell base station 3-3 by the F2UL and the PUCCH can be avoided from being concentrated on the UL CC of the macro cell. However, in a new network configuration in which the small cell uses the NCT, because the NCT can be used as only the SCell, the resolving method according to the related art cannot be applied.

As illustrated in FIG. 3, even when the PDSCH is transmitted from only the small cell base station 3-3, the ACK is transmitted to the macro cell base station 3-1, the ACK needs to be transmitted frequently from the macro cell base station 3-1 to the small cell base station 3-3 in short time, and delay requirement of backhaul links of the macro base station 3-1 and the small cell base station 3-3 may become severe.

The invention has been made in view of the above points and an object of the invention is to provide a wireless communication system that prevents a PUCCH from being concentrated on an uplink of a lagacy carrier and improves frequency efficiency of the uplink, in a wireless communication system performing a CA, particularly, a wireless communication system using a macro cell as a lagacy carrier and using a small cell as an NCT.

### Solution to Problem

An outline of the representative invention among the inventions disclosed in the present application will be described simply below.

A wireless communication method of performing communication using a plurality of frequency carriers, wherein a cell in which a terminal establishes connection is configured as a first cell and a cell other than the first cell is configured as a second cell, a frequency carrier corresponding to the first cell is configured as a first frequency carrier and a frequency carrier corresponding to the second cell is configured as a second frequency carrier, a base station transmits information to configured a frequency carrier transmitting information of a control channel of an uplink of a physical layer to the second frequency carrier to the terminal by a control signal of an higher layer, and the terminal transmits the information of the control channel of the uplink of the physical layer using the second frequency carrier, on the basis of the transmitted information.

### Advantageous Effects of Invention

According to the invention, in a wireless communication system performing a CA, particularly, a wireless communication system using a macro cell as a lagacy carrier and using a small cell as an NCT, a problem when a PUCCH is concentrated on an uplink of the lagacy carrier (that is, the macro cell) can be resolved and frequency efficiency of the uplink can be improved.

Other objects, configurations, and effects of the invention will become apparent from the following description of embodiments.

### BRIEF DESCRIPTION OF DRAWINGS

FIG. 1 is a diagram illustrating an example of a network configured by a macro cell and a small cell.

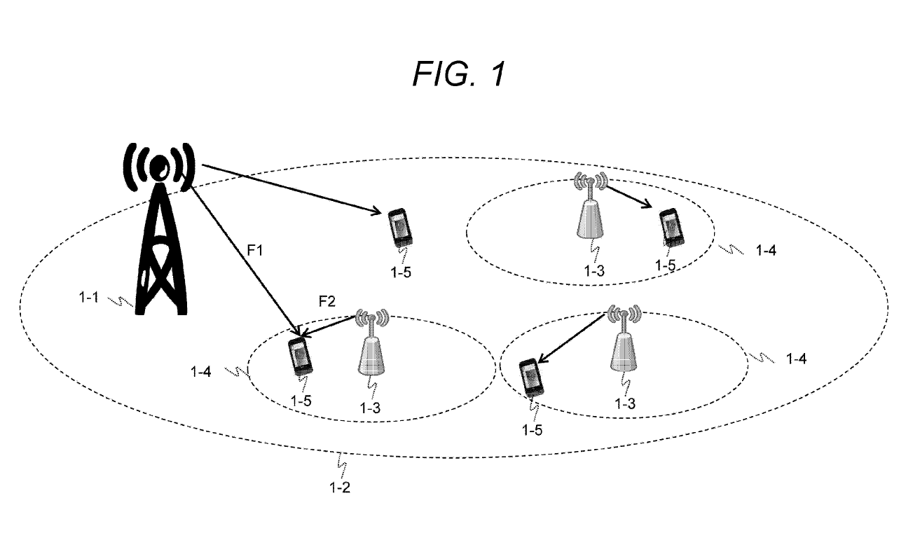

FIG. 2 is a diagram illustrating an example of resource structures of a legacy carrier and a new carrier type.

FIG. 3 is a diagram illustrating an example of a network configuration to perform a CA using the macro cell as the legacy carrier and using the small cell as the new carrier type.

FIG. 4 is a schematic diagram of a first embodiment of the invention.

FIG. 5 is a diagram illustrating an example of an operation sequence of the first embodiment of the invention.

FIG. 6 is a diagram illustrating a problem when the number of small cells is large.

FIG. 7 is a schematic diagram of a second embodiment of the invention.

FIG. 8 is a diagram illustrating an example of an operation sequence of the second embodiment of the invention.

FIG. 9 is a schematic diagram of a third embodiment of the invention.

FIG. 10 is a diagram illustrating an example of an operation sequence of the third embodiment of the invention.

FIG. 11 is a diagram illustrating an example of an operation sequence of a fourth embodiment of the invention.

FIG. 12 is a diagram illustrating an example of a configuration of abase station according to the invention.

FIG. 13 is a diagram illustrating an example of a configuration of abase station according to the invention in the case in which a centralized base station configuration is used.

### DESCRIPTION OF EMBODIMENTS

Embodiments of the invention will be described hereinafter with reference to the drawings.

In the embodiments described below, the invention will be described in a plurality of sections or embodiments when required as a matter of convenience. However, these sections or embodiments are not irrelevant to each other unless otherwise stated and one relates to the entire or part of the other as a modification, details, or a supplementary explanation thereof. Each embodiment may be executed individually. However, each embodiment may be combined and executed.

In addition, in the embodiments described below, when referring to the number of elements (including the number of pieces, values, amounts, ranges, and the like), the number of the elements is not limited to a specific number unless otherwise stated or except for the case in which the number is apparently limited to a specific number in principle and the number larger or smaller than the specified number is also applicable.

In addition, in the embodiments described below, it goes without saying that components (including element steps) are not always indispensable unless otherwise stated or except for the case in which the components are apparently indispensable in principle.

Similarly, in the embodiments described below, when shapes of the components, a positional relation thereof, and the like are mentioned, the substantially approximate and similar shapes and the like are included therein unless otherwise stated or except for the case in which it is conceivable that they are not apparently excluded in principle. The same is applicable to the numerical values and the ranges described above.

### 1. First Embodiment

An object of a first embodiment is to distribute transmission of a PUCCH to a plurality of cells, that is, a plurality of UL CCs.

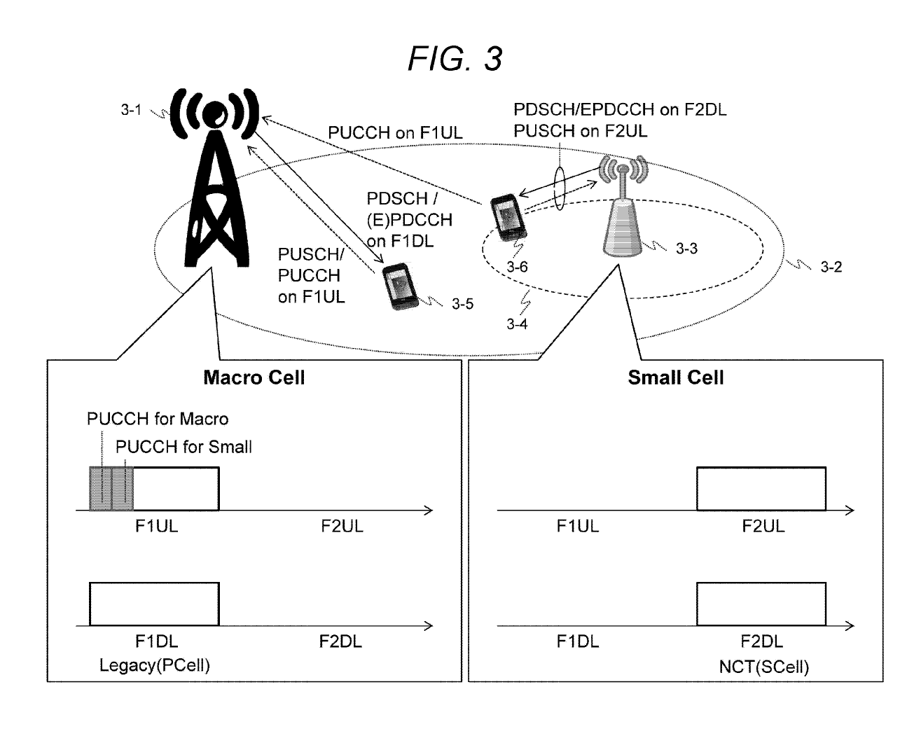

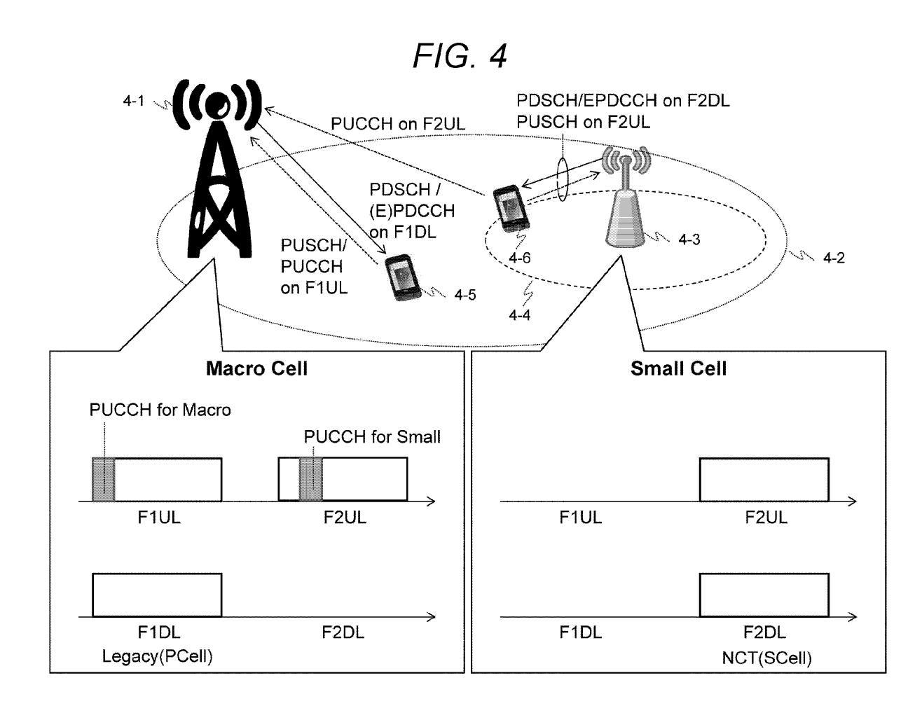

FIG. 4 is a schematic diagram of the first embodiment of the invention. Similar to FIG. 3, a lagacy carrier is used in a macro cell 4-2 and an NCT is used in a CC different from the macro cell in a small cell 4-4.

In FIG. 4, a terminal 4-5 is positioned at only the macro cell 4-2 and performs communication with a macro base station 4-1 using the lagacy carrier (F1DL and F1UL). That is, a PDCCH or an EPDCCH of the F1DL is transmitted from the macro base station 4-1 to the terminal 4-5 and a PDSCH for the terminal 4-5 is scheduled. In addition, in the F1DL, the PDSCH is transmitted from the macro base station 4-1 to the terminal 4-5. Likewise, a PUSCH of the terminal 4-5 is scheduled using the PDCCH or the EPDCCH of the F1DL. In addition, in the F1UL, the PUSCH is transmitted from the terminal 4-5 to the macro base station 4-1. The PUCCH of the terminal 4-5 is transmitted to the macro base station 4-1 using the F1UL.

Meanwhile, a terminal 4-6 is positioned in areas of both the macro cell 4-2 and the small cell 4-4. For this reason, the terminal performs communication with both the macro base station 4-1 and a small cell base station 4-3 by a CA using the macro cell 4-2 of the legacy carrier as a PCell and using the small cell 4-4 of the NCT as a SCell. At this time, an operation when information of a U-plane of the terminal 4-6 is transmitted and received is as follows, for example.

An EPDCCH on the F2DL is transmitted from the small cell base station 4-3 to the terminal 4-6 and a PDSCH or a PUSCH for the terminal 4-6 is scheduled. In addition, in the F2DL, the PDSCH is transmitted from the small cell base station 4-3 to the terminal 4-6. Alternatively, in the F2UL, the PUSCH is transmitted from the terminal 4-6 to the small cell base station 4-3.

In the first embodiment of the invention, as illustrated in FIG. 4, in a state in which the macro cell 4-2 is configured as PCell of the terminal 4-6, only the PUCCH is transmitted to the macro base station 4-1 by an uplink of the SCell, that is, the F2UL. Specifically, a serving cell (that is, the PCell or any SCell) used when the PUCCH is transmitted from the macro base station 4-1 or the small cell base station 4-3 to the terminal 4-6 is configured. This can be performed by signaling of an higher layer, for example. For example, the signaling of the higher layer is RRC signaling or control information (an MAC control element) in a media access control (MAC) layer. A specific operation sequence will be described later.

As such, when the CA using the legacy carrier and the NCT is performed, the serving cell to transmit the PUCCH is not fixed to the PCell, but is a parameter that can be configured from the base station to the terminal. Thereby, a problem that transmission of the PUCCH is concentrated on a CC of the uplink of the PCell can be resolved. As a result, frequency efficiency of the uplink of the legacy carrier can be improved. For example, in FIG. 4, the terminal 4-5 can increase an amount of resources that can be used for a data channel (PUSCH) of the uplink. In addition, a legacy terminal that is positioned at the macro cell or the small cell, that is, a terminal that cannot use a UL CC (F2UL) corresponding to the NCT for the PUSCH can increase an amount of resources that can be used for the PUSCH.

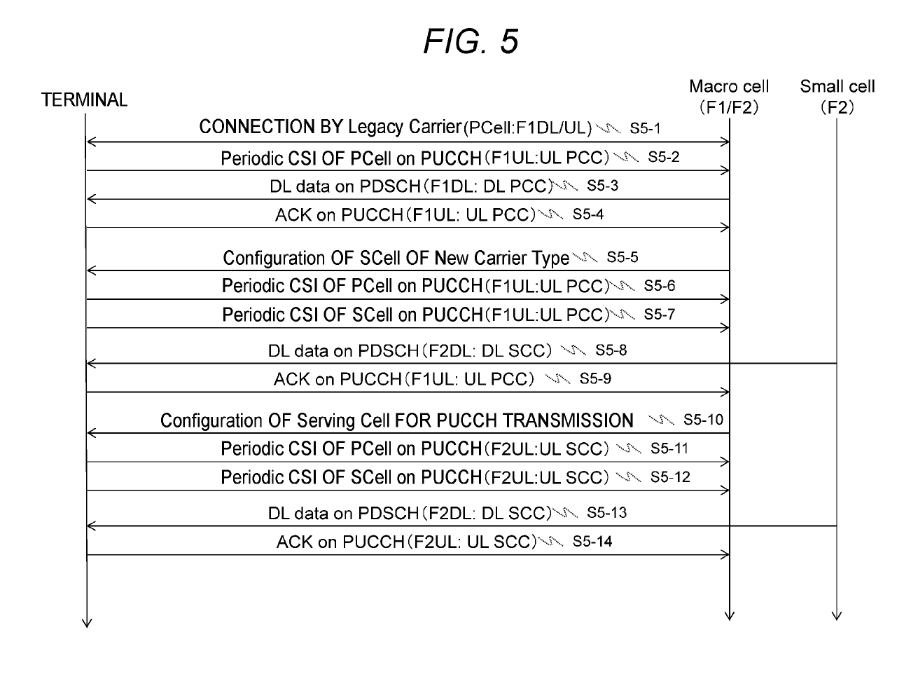

FIG. 5 is a diagram illustrating an operation sequence of the first embodiment of the invention. First, the terminal is connected to the macro cell of the legacy carrier, using the F1DL and the F1UL (S5-1). In S5-1, a random access procedure to be an initial access is performed and various RRC parameters such as the PDSCH, the PUSCH, and PUCCH are configured. The RRC parameters are described in NPL 4. At this time, the macro cell becomes the PCell. That is, the F1DL and the F1UL become a DL PCC and a UL PCC. The terminal measures CSI of the PCell using a reference signal transmitted by the PCell. In addition, the terminal transmits the measured CSI to the macro cell using the PUCCH on the F1UL (UL PCC) (S5-2). Because the CSI transmitted by the PUCCH is CSI transmitted periodically, the CSI becomes periodic CSI. In addition, a HARQ-ACK for data (PDSCH) of a downlink transmitted from the macro cell using the F1DL (DL PCC) is transmitted from the terminal to the macro cell by the PUCCH on the F1UL (UL PCC) (S5-3 and S5-4). Here, the data may be information of a C-plane and may be information of a U-plane. Likewise, information of the C-plane and the U-plane is simply called data hereinafter.

Next, the macro cell detects that the terminal is positioned at the small cell, on the basis of reception power information transmitted by the terminal, and configures a small cell of a new carrier type as the SCell (S5-5). In S5-5, configuration of the various RRC parameters for the SCell is included. Specifically, a cell ID (physical cell ID: PCI) of a physical layer of the SCell, a transmission mode, and a parameter of the EPDCCH are included. In addition, information showing whether the configured SCell is the new carrier type or the legacy carrier may be included. At this time, as illustrated in S5-6 or S5-7, the CSI of the PCell and the SCell is transmitted using the PUCCH on the F1UL (ULPCC). Likewise, a HARQ-ACK for the PDSCH transmitted from the small cell using the F2DL (DL SCC) is also transmitted using the PUCCH on the F1DL (UL PCC) (S5-8 and S5-9).

Next, the macro cell determines that the PUCCH of the terminal is transmitted by the SCell, according to various information and references such as an electric wave situation of the terminal and a use situation of PUCCH resources of the macro cell. In addition, the macro cell configures a serving cell for PUCCH transmission to the terminal (S5-10). This configuration is performed by signaling of the RRC, for example. However, a signal for the configuration may be transmitted from the small cell.

In the LTE standard, an index 0 (fixed value) is set to the PCell and indexes 1 to 7 are set to the SCell (this configuration is performed in S5-5). For this reason, in S5-10, any value of 1 to 7 may be configured as the index of the SCell to transmit the PUCCH. In addition, the terminal may determine that the PUCCH is transmitted on the PCell, when the configuration is not performed. Thereby, overhead necessary for the configuration can be reduced. In the case in which a certain SCell is configured, the terminal may determine that the PUCCH is transmitted on the PCell, when the configuration of the SCell is released. Alternatively, in S5-10, any value of 0 to 7 including the index of the PCell may be configured.

When a plurality of SCells are used, any SCell of the plurality of SCells is configured as a serving cell for the PUCCH transmission. At this time, communication quality of the terminal can be improved by selecting the SCell in which reception power is large. Alternatively, the overhead for the PUCCH in each SCell is equalized by selecting the SCell in which the use frequency for the transmission of the PUCCH is small or an amount of resources used for the PUCCH is small and the resources can be effectively used.

In S5-10, the PUCCH resources may be configured for the PUCCH transmitted on the SCell. Here, the parameter to determine the PUCCH resources is configured as a parameter different for each of the HARQ-ACK, the CSI, and the SR. For example, the HARQ-ACK uses a parameter called n1PUCCH-AN represented by values of 0 to 2047. The CSI uses a parameter called PUCCHResourceIndex represented by values of 0 to 1185. The SR uses a parameter called sr-PUCCH-ResourceIndex represented by values of 0 to 2047. An amount of PUCCH resources needed in each serving cell is different according to the number of terminals transmitting the PUCCH in each serving cell. As described below, a frequency resource (that is, a number of a PRB) to transmit the PUCCH is determined by the PUCCH resource. For this reason, the parameter to determine the PUCCH resource needs to be configured according to a use situation of the PUCCH resource of each serving cell. Therefore, as described above, when the serving cell to transmit the PUCCH is changed from the PCell to the SCell, the PUCCH resource is reconfigured according to the use situation of the PUCCH resource of the SCell, so that the overhead of the PUCCH can be reduced.

Then, the terminal transmits the CSI of the PCell or the SCell using the F2UL to be the UL CC (UL SCC) of the SCell configured by S5-10 (S5-11 and S5-12). In addition, the HARQ-ACK for the PDSCH transmitted on the F2DL (DL SCC) is transmitted on the F2UL (UL SCC) (S5-13 and S5-14).

### 2. Second Embodiment

An object of a second embodiment is to distribute transmission of a PUCCH to a space, that is, a different cell direction of the same CC.

In the LTE standard, a PUCCH for each cell is distinguished by a PCI. Specifically, if the PCI is different, initial values of a signal sequence (base sequence) to be a base of a signal sequence of the PUCCH and a random sequence to determine a pattern of cyclic shift are different. Meanwhile, PUCCHs between terminals in the same cell ID are distinguished by PUCCH resources. Specifically, if the PUCCH resources are different, a frequency resource (that is, a number of a PRB) used for the PUCCH, a cyclic shift amount, and an orthogonal sequence multiplied with a time domain are different. The details thereof are disclosed in NPL 3.

When PCI used in PUCCHs transmitted by different terminals is different, interference of the PUCCHs of the terminals is randomized even though the terminals use the same PUCCH resource. As a result, the PUCCHs of the terminals can be distinguished. Here, when a plurality of CCs are used, different PCI may be used between the CCs, even in the same base station.

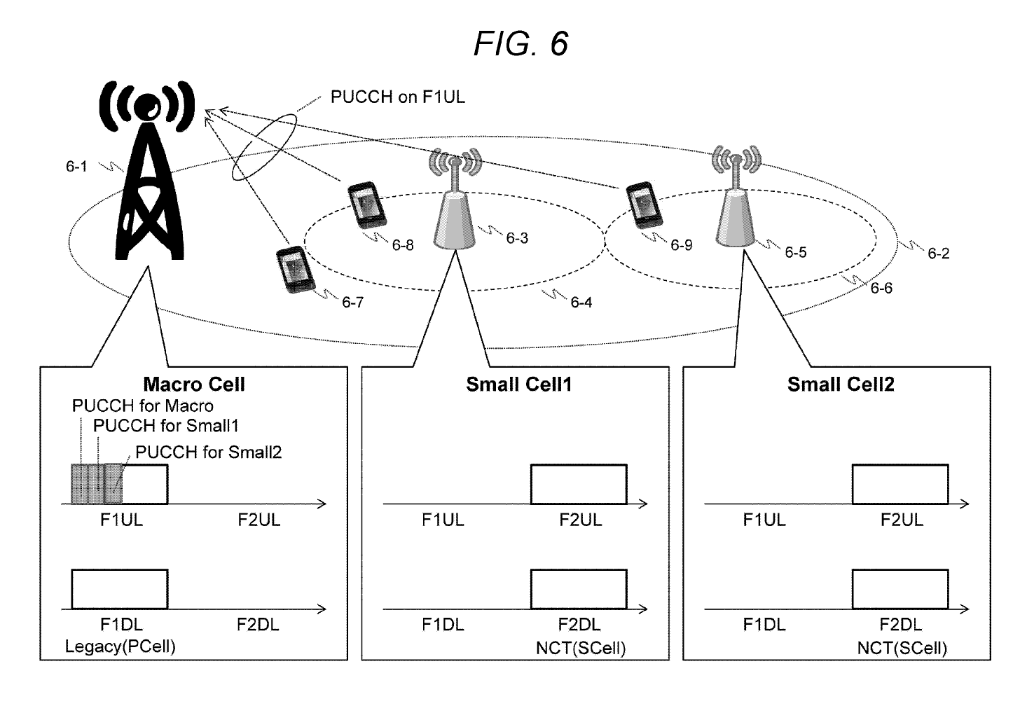

However, when a CA using a legacy carrier and an NCT is performed, a problem illustrated in FIG. 6 occurs. In FIG. 6, two small cell base stations 6-3 and 6-5 and small cells 6-4 and 6-6 formed by the base stations exist in a macro cell 6-2. Similar to FIG. 3, in the macro cell 6-2, the legacy carrier is used in F1DL and in the small cells 6-4 and 6-6, the NCT is used in F2DL. Terminals 6-8 and 6-9 positioned in areas of both the macro cell 6-2 and the small cells 6-4 and 6-6 perform communication using the CA using the macro cell of the legacy carrier as a PCell and using the small cell of the NCT as a SCell.

At this time, similar to the case of FIG. 3, PUCCHs of the terminals 6-8 and 6-9 positioned at the small cells 6-4 and 6-6 are transmitted to the macro base station 6-1 in the F1UL. This is equivalent to that the PUCCHs of the terminals 6-8 and 6-9 are generated using the PCI of the macro cell 6-2, more specifically. This is based on that the PUCCH signal is generated using the PCI of the PCell, when the CA is performed.

For this reason, PUCCHs of the terminal 6-7 positioned in only the area of the macro cell 6-2 and the terminals 6-8 and 6-9 positioned in the areas of both the macro cell 6-2 and the small cell 6-4 or 6-6 need to be distinguished by using different PUCCH resources, as illustrated in FIG. 6. As a result, an amount of PUCCH resources needed in the F1UL may increase and frequency efficiency of an uplink of the macro cell may be degraded. If the number of small cells increases, PUCCH resources proportional to the number of small cells are necessary. For this reason, overhead of the PUCCH in the macro cell further increases.

In the second embodiment of the invention, a method of resolving the above problem without changing a serving cell to transmit the PUCCH is disclosed. This can be realized by using coordinated multi point operation (CoMP) technology of the uplink.

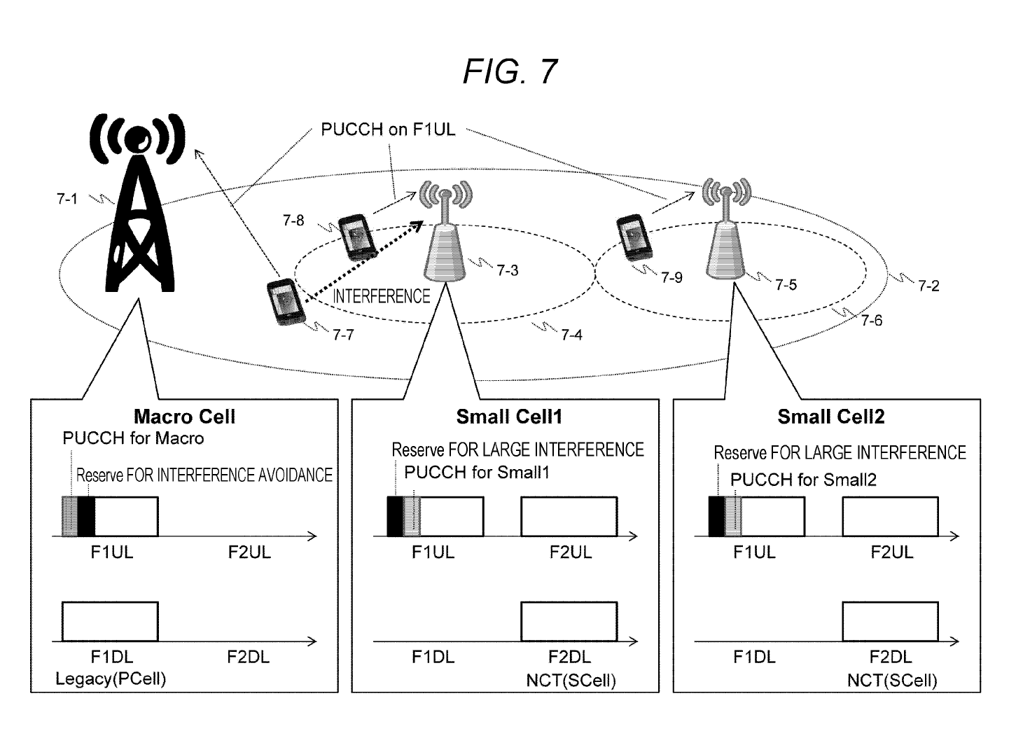

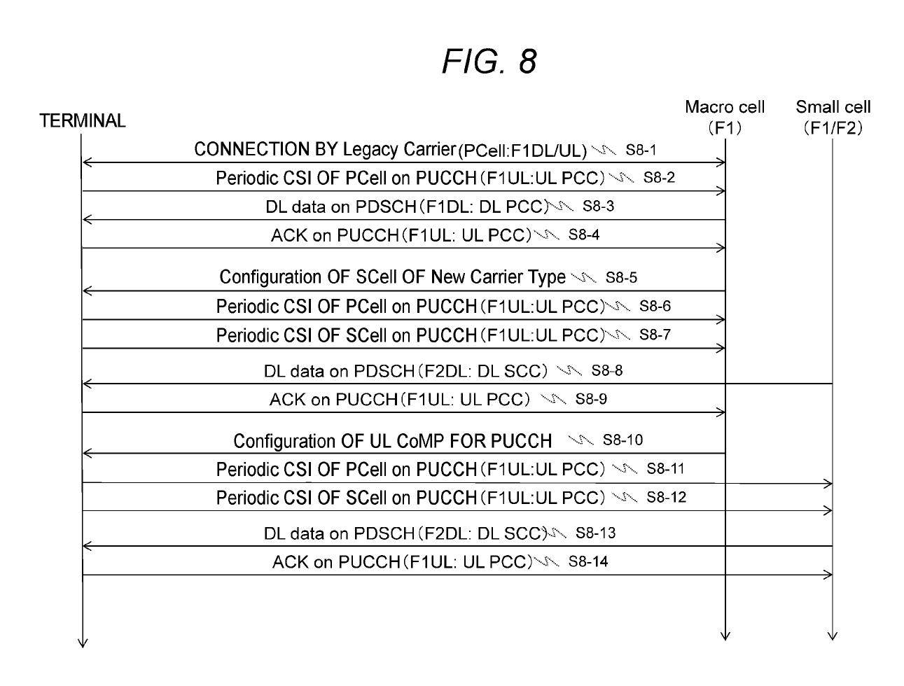

FIG. 7 is a schematic diagram of the second embodiment of the invention. A basic configuration is the same as that of FIG. 6. However, in FIG. 7, PUCCHs of a terminal 7-8 and a terminal 7-9 are transmitted to small cell base stations 7-3 and 7-5 using the F1UL. In the small cells 7-4 and 7-6, the same PUCCH resource is used. In the second embodiment of the invention, as illustrated in FIG. 8, configuration is given to the terminals 7-8 and 7-9 to use PCIs different from that of a macro cell 7-2 (that is, a PCell) to generate a signal of the PUCCH. Configuration is given to the terminals 7-8 and 7-9 to use different PCIs. For this reason, as illustrated in FIG. 7, even though the same PUCCH resources are used in the terminals 7-8 and 7-9 using the macro cell 7-2 as a common PCell, the PUCCHs can be distinguished. As a result, as illustrated in FIG. 7, transmission of the PUCCH can be distributed to different cells and frequency efficiency of the uplink of the macro cell 7-2 can be improved. Because the PUCCH is transmitted to a small cell base station, consumption power necessary for transmission can be reduced. However, the PCI may be a virtual PCI used to generate a signal sequence of the PUCCH and may be the same as a PCI (that is, a PCI of a SCell) of a small cell in F2DL/UL. However, the PCI does not need to be the same as the PCI of the small cell. For this reason, values of 0 to 503 equal to the values of the PCI may be taken and values equal to or larger than 504 may be taken. Hereinafter, the virtual PCI is called as a virtual cell ID (VCI).

Here, different PUCCH resources are used in the PUCCH in the macro cell 7-2 and the small cells 7-4 and 7-6 and frequency resources corresponding to the PUCCH resources are reserved. This is because transmission power of a terminal (for example, the terminal 7-7) performing transmission of the uplink for the macro base station is large and large interference occurs in a small cell (for example, 7-4) and reception performance of the PUCCH in the small cell is degraded even though the different PCIs are used.

FIG. 8 is a diagram illustrating an operation sequence of the second embodiment, of the invention. A sequence from S8-1 to S8-9 is the same as the sequence from S5-1 to S5-9 in FIG. 5. In S8-10, the macro cell determines that the PUCCH of the terminal is transmitted to the small cell, according to various information and references such as an electric wave situation of the terminal or a use situation of the PUCCH resource of the macro cell. In addition, the macro cell configures a parameter for the UL CoMP for PUCCH to the terminal. Specifically, a parameter such as a VCI used to generate the signal sequence of the PUCCH transmitted on the F1UL or the PUCCH resource is configured. As illustrated in FIG. 7, when a plurality of small cells exist, configuration may be given to the different small cells to use different VCIs. In addition, information to determine path loss used to determine transmission power of the PUCCH or a parameter regarding target reception power may be configured. This configuration is performed by signaling of the RRC. However, a signal for the configuration may be transmitted from the small cell.

Then, the terminal transmits the CSI of the PCell or the SCell to the small cell using the parameter such as the VCI configured by S8-10 and the F1UL (UL PCC) (S8-11 and S8-12). In addition, the HARQ-ACK for the PDSCH transmitted on the F2DL (DL SCC) is transmitted to the small cell using the F1UL (UL PCC) (S8-13 and S8-14).

### 3. Third Embodiment

In a third embodiment, an object of a third embodiment is to distribute transmission of a PUCCH to a frequency carrier direction and a space direction.

In the second embodiment, as illustrated in FIG. 7, only the transmission destination of the PUCCH is changed (that is, the PCI to generate the signal sequence of the PUCCH is changed to the VCI of the different value). For this reason, the PUCCH resources need to be distinguished in the macro cell and the small cell to prevent the PUCCH of the terminal transmitting the PUCCH to the macro cell from causing large interference in the small cell and frequency use efficiency of the uplink in the macro cell may not be sufficiently improved. In addition, in the first embodiment, as illustrated in FIG. 4, only the CC transmitting the PUCCH is changed. For this reason, even though the F2UL is not used for the communication of the data (PUSCH) of the uplink in the macro cell, the macro base station needs to have a reception function of the F2UL to receive the PUCCH and the configuration of the macro base station may be complicated. Meanwhile, in the second embodiment, even though the F1UL is not used for the communication of the data (PUSCH) of the uplink in the small cell, the small cell base station needs to have a reception function of the F2UL to receive the PUCCH and the configuration of the small cell base station may be complicated.

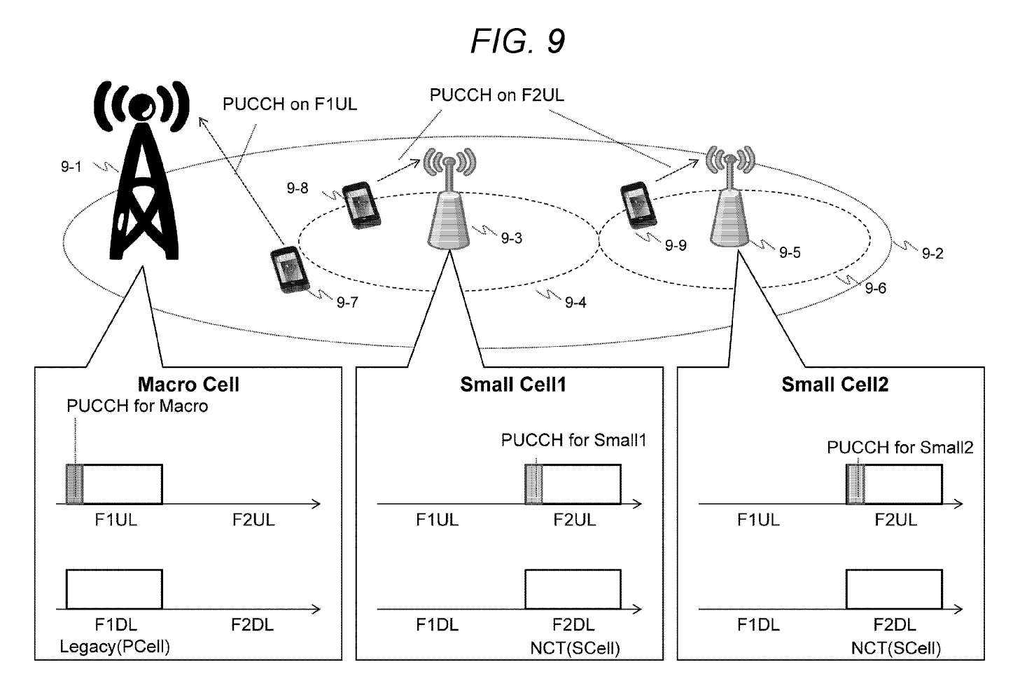

FIG. 9 is a schematic diagram of the third embodiment of the invention to resolve the above problem. A basic configuration is the same as those of FIGS. 6 and 7. However, FIG. 9 is different from FIGS. 6 and 7 in that a CC transmitting PUCCHs of terminals 9-8 and 9-9 positioned at small cells 9-4 and 9-6 becomes F2UL and is transmitted to small cell base stations 9-3 and 9-5. As illustrated in FIG. 9, when a CA using a macro cell of a legacy carrier as a PCell and using a small cell of an NCT as an SCell is performed, the CC transmitting the PUCCH is changed from the F1UL to the F2UL and a transmission destination, that is, a PCI used to generate a signal sequence of the PUCCH is changed. Thereby, an interference problem between a terminal 9-7 transmitting the PUCCH to a macro base station 9-1 and terminals 9-8 and 9-9 transmitting the PUCCH to the small cell base stations 9-3 and 9-5 can be resolved. In the macro base station 9-1, signals (the PUCCH and the PUSCH) of the uplink may be received on only the F1UL and in the small cell base stations 9-3 and 9-5, signals (the PUCCH and the PUSCH) of the uplink may be received on only the F2UL. Therefore, configurations of the macro base station 9-1 and the small cell base stations 9-3 and 9-5 can be simplified.

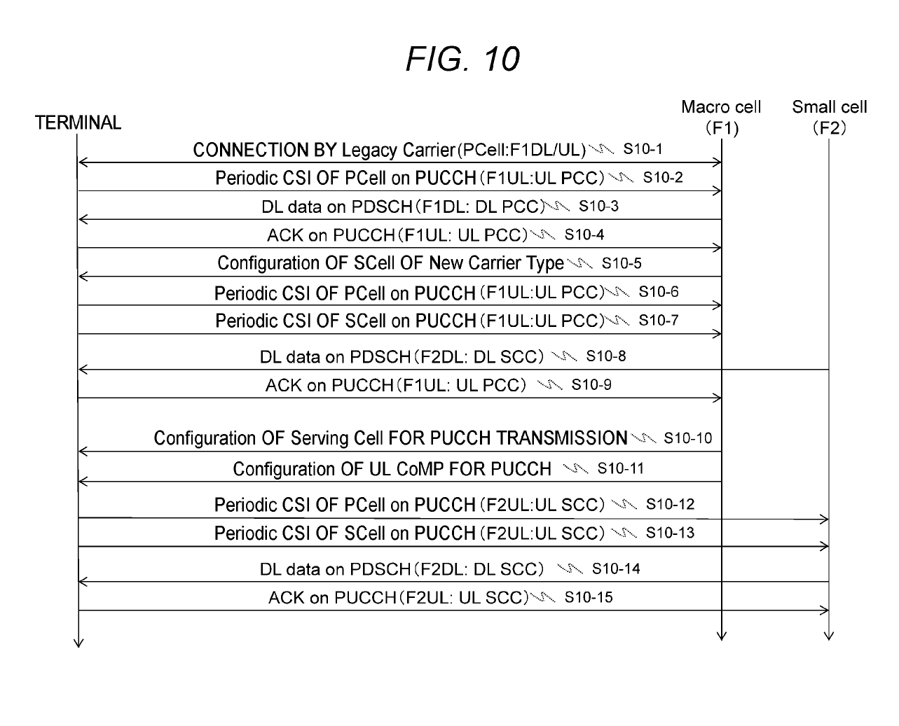

FIG. 10 illustrates an operation sequence of the third embodiment of the invention. In FIG. 10, a sequence from S10-1 to S10-9 is the same as the sequence from S5-1 to S5-9 in FIG. 5. Next, the macro cell determines that the PUCCH of the terminal is transmitted to the small cell, using the uplink of the SCell, according to various information and references such as an electric wave situation of the terminal or a use situation of the PUCCH resource of the macro cell or the small cell. In addition, the macro cell configures a serving cell for PUCCH transmission to the terminal (S10-10). A parameter configured by S10-10 is the same as the parameter configured by S5-10. Next, in S10-11, the macro cell configures a parameter for UL CoMP to the terminal and the PUCCH (S10-11).

However, when the same parameters as the parameters configured by S10-1, S10-5, and S10-10 are used to transmit the PUCCH, S10-11 may be omitted. For example, when the PCI of the SCell configured in S10-5 and the VCI used to generate the signal sequence of the PUCCH are the same, configuration of the VCI in S10-11 can be omitted. If an index of the SCell to transmit the PUCCH is configured to the terminal in S10-10 and the VCI to generate the signal sequence of the PUCCH is not configured in S10-11, the terminal may determine that the PCI (configured by S10-5) of the same SCell as the index configured in S10-10 is used as the PCI to generate the signal sequence of the PUCCH. As such, configuration of the VCI in S10-11 is omitted, so that overhead necessary for the configuration can be reduced. However, when the VCI is configured in S10-11, the terminal generates the signal sequence of the PUCCH using the VCI configured in S10-11, regardless of the PCI of the SCell configured in S10-10.

When the SCell for the PUCCH transmission is configured in S10-10, the terminal may use path loss of the SCell configured in S10-10 as path loss used to measure transmission power of the PUCCH. Thereby, overhead necessary for configuring a parameter of power control when the SCell is configured can be reduced. Alternatively, it may be configured whether the transmission power of the PUCCH is determined using the path loss of which serving cell (the PCell or any SCell), as a different parameter. However, similar to the VCI, when a new parameter of power control is configured by S10-11, the terminal follows the configuration.

In addition, order of S10-11 and S10-10 may be reversed and S10-11 and S10-10 may be set as one RRC configuration. In addition, configuration of S10-10 or S10-11 may be transmitted from the small cell.

Then, the terminal transmits the CSI of the PCell or the SCell to the small cell, using the UL CC (UL SCC) of the SCell configured in S10-10 and S10-11 and the VCI configured by S10-11 (or the PCI of the SCell configured in S10-10) (S10-12 and S10-13). The HARQ-ACK for the PDSCH transmitted by the F2DL (DL SCC) is also transmitted to the small cell using the F2UL (UL SCC) (S10-14 and S10-15).

However, the configuration illustrated in FIG. 10 is performed for each terminal. That is, the serving cell (SCell or PCell) transmitting the PUCCH may be different for each terminal. For example, a certain terminal using the same small cell as the SCell may transmit the PUCCH using the SCell (UL SCC) and a different terminal may transmit the PUCCH using the PCell (UL PCC), similar to the related art. When a plurality of SCells (UL SCCs) exist in the small cell, the PUCCH may be transmitted using a different SCell for each terminal.

In addition, in the LTE, the SCell can be activated or deactivated. In the deactivated SCell, the terminal does not perform reception (monitoring) of the PDCCH/EPDCCH, reception of the downlink data (PDSCH), transmission of the uplink data (PUSCH) or the reference signal, and measurement (and transmission) of the CSI. For this reason, when the SCell configured in S10-10 in FIG. 10 (and S5-10 in FIG. 5) is deactivated, the PUCCH may not be transmitted and the HARQ-ACK or the CSI of the PCell or the different activated SCell may not be transmitted.

In order to resolve the above problem, it is thought that transmission of the PUCCH returns to the uplink (UL PCC) of the PCell, similar to the related art, when the SCell transmitting the PUCCH is deactivated. In contrast, when the SCell transmitting the PUCCH is activated from a deactivation state, the transmission of the PUCCH may restart in the configured SCell. However, timing when the transmission of the PUCCH returns to the PCell or the transmission in the SCell restarts is preferably recognized equally by the terminal and the base station. For example, it is thought that the timing is predetermined as timing after 8 subframes from reception of a command of the activation/deactivation, similar to the current LTE standard. In addition, this operation can be automatically executed without performing additive resetting in particular.

### 4. Fourth Embodiment

A fourth embodiment of the invention discloses a method in which a serving cell (CC) transmitting a PUCCH is different according to content of information transmitted by the PUCCH. That is, a plurality of serving cells transmitting the PUCCH exist.

Different from the command of the activation/deactivation described above, in a configuration by RRC, setting time is long and a plurality of PDSCHs may exist. For this reason, in the first to third embodiments, during a period where a CC transmitting the PUCCH or a VCI used to generate a signal sequence of the PUCCH is configured or reconfigured, a base station may not know the CC or the VCI used to transmit the PUCCH. This is applicable to the case in which configuration of the SCell is modified or use of the SCell is released. This may occur in the case of handover (that is, a change in the PCell).

In order to avoid this problem, in the fourth embodiment of the invention, essential information is transmitted on only an uplink (UL PCC) of the PCell. A method described below may be easily combined with the first to third embodiments.

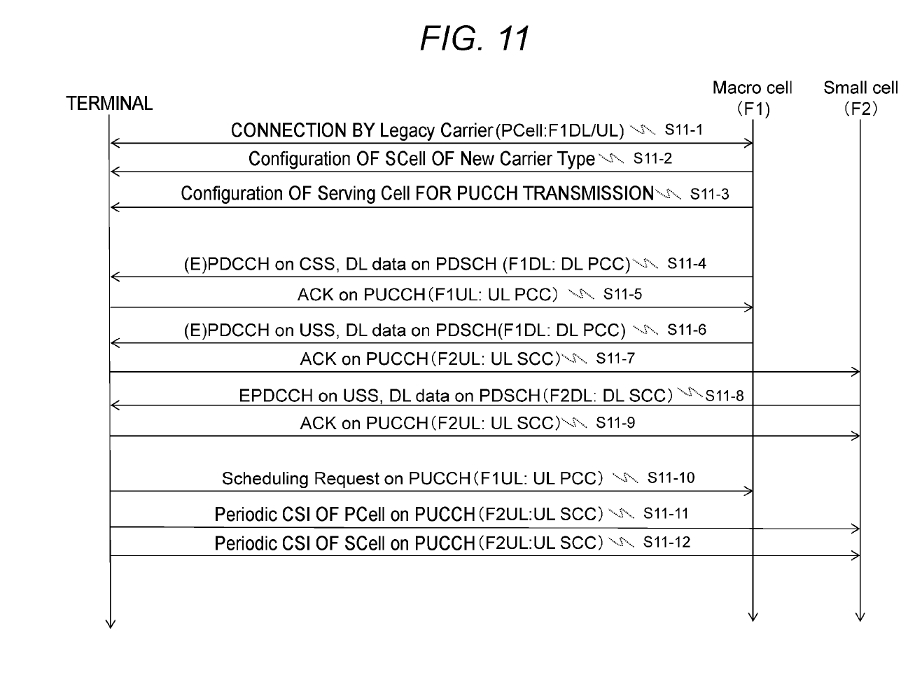

FIG. 11 is a diagram illustrating an example of an operation sequence of the fourth embodiment. A sequence of initial access (S11-1) and an operation when a SCell of an NCT is configured (S11-2) may be the same as the content described in S5-1 to S5-9 in FIG. 5. In addition, an operation for setting a serving cell for PUCCH transmission in S11-3 may be the same as the content described in S10-10 of FIG. 10. Although not illustrated in FIG. 11, a parameter regarding a UL CoMP may be configured like S10-11 of FIG. 10.

In S11-4 to S11-9, an operation when a serving cell (CC) transmitting the PUCCH is changed according to a search space used to schedule the PDSCH, for the HARQ-ACK transmitted by the PUCCH, is described.

Here, the search space is a space in which the PDCCH or the EPDCCH is transmitted. In the search space, a common search space (CSS) and a UE-specific search space (USS) exist. The CSS is used for scheduling of system information transmitted in a cell or information regarding paging and random access. In addition, the CSS is used to transmit RRC signaling for handover or information for resetting (reconfiguration) of various RRC parameters. For this reason, the space of the CSS is used commonly to terminals in the cell and a method of transmitting the PDSCH scheduled by the CSS (in at least a normal subframe) is used commonly to the terminals, using different transmission modes. Specifically, the PDSCH scheduled by the CSS is transmitted using single antenna transmission or transmission diversity, according to the number of antenna ports of the CRS. As a result, even when the transmission mode is changed by the RRC signaling, the used transmission method can be recognized equally by the base station and the terminal.

Meanwhile, because it is assumed that the USS is used to transmit other data of each terminal, in the PDSCH scheduled by the USS, the transmission method or the parameter used therein is different according to the transmission mode. When the CA is used, both the CSS and the USS are used in scheduling of the PCell. However, only the USS is used in scheduling of the SCell.

For this reason, in FIG. 11, when the PDSCH is scheduled from the macro cell using the CSS of the PDCCH (or the EPDCCH), in the DL PCC (F1DL) (S11-4), the HARQ-ACK for the PDSCH is transmitted using the uplink of the PCell, that is, the UL PCC (F1UL) (S11-5). Meanwhile, when the PDSCH of the PCell is scheduled by the USS of the (E)PDCCH (S11-6), the HARQ-ACK for the PDSCH is transmitted to the small cell using the serving cell configured by S11-3, that is, the PUCCH in the UL SCC (F2UL) (S11-7). Likewise, the HARQ-ACK for the PDSCH of the SCell scheduled by the USS of the EPDCCH is also transmitted to the small cell using the PUCCH, in the UL SCC (F2UL) (S11-8 and S11-9).

S11-10 to S11-12 are an operation for handling other information transmitted by the PUCCH. In S11-10, a scheduling request (SR) of the uplink data (PUSCH) from the terminal is transmitted on the UL PCC, because priority of information is high. Meanwhile, because the priority of the information is low for the CSI, the CSIs of the PCell and the SCell are transmitted on the UL SCC configured in the S11-3 (S11-11 and S11-12).

However, the all HARQ-ACK for the PDSCH of the PCell may be transmitted on the UL PCCs, regardless of distinguishing of the CSS and the USS. Likewise, the periodic CSI of the PCell may be transmitted on the UL PCC. In addition, the serving cell transmitting each of the HARQ-ACK, CSI, and SR may be configured independently. The serving cell transmitting the CSI may be configured independently for the PCell and each SCell.

### 5. Device Configuration

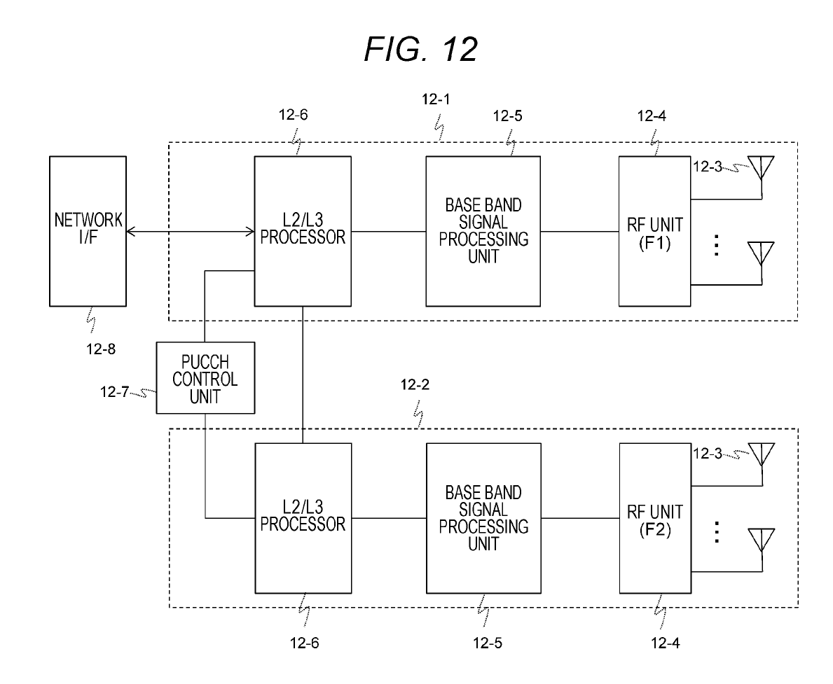

FIG. 12 illustrates an example of a device configuration of a base station according to the invention. A device illustrated in FIG. 12 can be realized by a memory, a digital signal processor (DSP), a field programmable gate array (FPGA), a central processing unit (CPU), and a micro-processing unit (MPU).

12-1 shows a macro base station and 12-2 shows a small cell base station.

An antenna 12-3 transmits a radio frequency (RF) signal of a downlink transferred from an RF unit 12-4. In addition, the antenna 12-3 receives an RF signal of an uplink transmitted from a terminal.

An RF unit 12-4 converts a base band signal of a downlink input from a base band signal processing unit 12-5 into an RF signal and transmits the RF signal through the antenna 12-3. In addition, the RF unit 12-4 converts the RF signal of the uplink input from the antenna 12-3 into a base band signal and inputs the base band signal to a base band signal processing unit 12-5. The RF unit 12-4 also includes a power amplifier. In FIG. 12, the RF unit 12-4 of the macro base station 12-1 converts an RF signal having a frequency of F1 and the RF unit 12-4 of the small cell base station 12-2 converts an RF signal having a frequency of F2. However, as illustrated in FIG. 4 or 7, when a PUCCH needs to be received on F2UL and F1UL in the macro base station 12-1 and the small cell base station 12-2 respectively, the individual RF units also convert the RF signals having the frequencies of F2 and F1. In addition, the RF unit 12-4 may have taken a remote radio head (RRH) configuration in which the RF unit is connected to the base band signal processing unit 12-5 through a wired circuit such as an optical fiber. In this case, an optical interface (photoelectric converter) and an optical fiber are included between the RF unit 12-4 and the base band signal processing unit 12-5.

The base band signal processing unit 12-5 executes signal processing of a physical layer of a data channel (PDSCH) and control channels (PDCCH, EPDCCH, PHICH, and PCFICH) of a downlink of each terminal input from an L2/L3 processor 12-6, generation of a control channel of the physical layer, and signal processing of the physical layer of a data channel (PUSCH) and a control channel (PUCCH) of an uplink input from the RF unit 12-4. The signal processing of the downlink is error correction encoding of a data signal and a control signal, rate matching, modulation, MIMO signal processing such as layer mapping or precoding, mapping to the RE, and inverse fast Fourier transform (IFFT), specifically. The signal processing unit 12-5 also performs generation of reference signals (CRS, CSI-RS, and DMRS) used to perform propagation channel estimation for demodulation in the terminal or measurement of CSI and reception power or insertion of reference signals into the REs. Generation of a synchronization signal or a broadcast channel (Physical Broadcast Channel: PBCH) of a physical layer and insertion into the RE are performed. The base band signal generated by, the signal processing is transmitted to the RF unit 12-4. The signal processing of the uplink is FFT, demapping of the RE, MIMO signal processing such as multiplication of MIMO reception weight or layer demapping, demodulation, and error correction decoding, for a signal input from the RF unit 12-4. Channel estimation or reception power measurement using the RS of the uplink and CSI measurement of the uplink are performed. The demodulated data channel or control channel is transmitted to the L2/L3 processor 12-6.

The L2/L3 processor 12-6 is a processor that executes processing of a layer 2 and a layer 3 of the base station. The L2/L3 processor 12-6 stores data of each terminal transmitted from a gateway through a network interface (I/F) 12-8 or a control signal received from other base station or a mobility management entity (MME) in a buffer. In addition, scheduling to determine a terminal performing communication or time and a frequency resource allocated to the terminal, management of the HARQ, processing of a packet, concealing processing of a radio link, and generation of a control signal of an higher layer for the terminal are performed. The determination of the RRC parameter or various RRC configurations are performed by the L2/L3 processor 12-6. In FIG. 12, because it is assumed that the small cell is the NCT and does not operate as the PCell, a configuration in which only the macro base station 12-1 is connected to the network I/F 12-8 is taken. However, the small cell base station 12-2 may also be connected to the network I/F.

In addition, the L2/L3 processor 12-6 of the macro base station 12-1 determines that the small cell base station 12-2 is configured as the SCell, on the basis of a position or an electric wave situation of the terminal and traffic (that is, the CA is performed). The data of the terminal configured as the SCell is transferred to the L2/L3 processor 12-6 of the small cell base station 12-2. In addition, the L2/L3 processor 12-6 of the small cell base station 12-2 transfers the received signal of the uplink of each terminal to the L2/L3 processor 12-6 of the macro base station 12-1.

The PUCCH control unit 12-7 has a function of determining the serving cell to which the PUCCH is transmitted by each terminal, on the basis of a use situation of the PUCCH resources of the macro base station 12-1 and the small cell base station 12-2, the traffic, and the electric wave situation of each terminal, as illustrated in the first to fourth embodiments. For example, when an amount of PUCCH resources needed in the macro base station 12-1 is more than a threshold value, the PUCCH control unit 12-7 determines that a PUCCH of a certain terminal positioned at the small cell is transmitted to the small cell base station 12-2 (that is, in the SCell). Information of the serving cell to which the PUCCH is transmitted by the terminal is transmitted to the L2/L3 processors of the macro base station 12-1 and the small cell base station 12-2. The information is transmitted as the RRC configuration from the macro base station 12-1 or the small cell base station 12-2 to the terminal, by the method described above. In FIG. 12, the PUCCH control unit is described as a device different from the macro base station 12-1 or the small cell base station 12-2. However, the PUCCH control unit may be a part of the functions in the L2/L3 processor 12-6 of the macro base station 12-1.

The network I/F 12-8 is an interface used when the macro base station 12-1 is connected to a core network through a backhaul link. The macro base station 12-1 is connected to the core network through the network I/F 12-8, so that the macro base station 12-1 can perform communication with the gateway, the mobility management entity, and other base station.

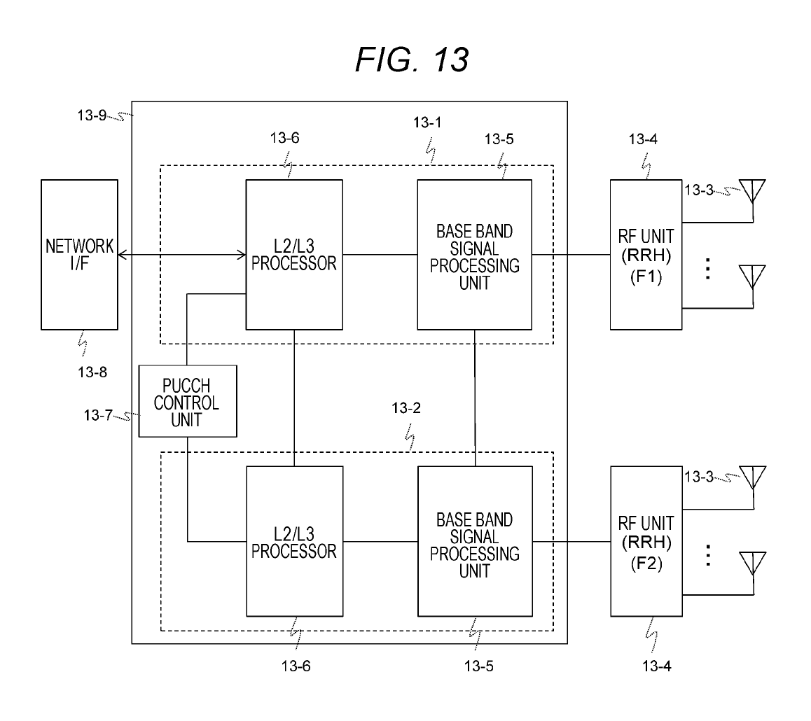

In the device configuration described above, the macro base station 12-1 and the small cell base station 12-2 are described as the different devices. However, a configuration of a centralized base station illustrated in FIG. 13 may be taken. A centralized base station 13-9 may be arranged at the same position as that of the macro base station in FIG. 9, for example. However, the centralized base station 13-9 may be arranged at the different position from that of the macro base station and the small cell base station. As illustrated in FIG. 13, the centralized base station 13-9 includes L2/L3 processors 13-6 and base band signal processing units 13-5 of both the macro cell and the small cell. FIG. 13 illustrates an example of a configuration in which 13-1 executes processing of L2/L3 and the base band of the macro cell and 13-2 executes processing of L2/L3 and the base band of the small cell. The L2/L3 processor 13-6 and the base band signal processing unit 13-5 may have the same configurations as the configurations of FIG. 12 and a cooperative configuration is enabled. Also, the PUCCH control unit 13-7 may have the same configuration as the configuration of FIG. 12. In addition, each of the L2/L3 processors 13-6 and the base band signal processing units 13-5 of the macro cell and the small cell may be one device. The RF unit 13-4 and the antenna 13-3 exist as an RRH at each site and the RF unit 13-4 and the base band signal processing unit 13-5 are connected by a backhaul link such as an optical fiber.

### 6. Reception Power Measurement Method of NCT

In the embodiments of the invention described above, reception power (reference signal received power: RSRP) of a reference signal of the small cell is needed to determine that the macro base station uses the small cell as the SCell. In the wireless communication system according to the related art configured by only the legacy carrier, the reception power is measured using the CRS. However, as described above, because the CRS is transmitted only with a period of 5 subframes in the NCT, the method according to the related art cannot be used.

As a method of measuring the reception power of the NCT, two methods are thought roughly. A first method is a method using a CRS corresponding to one antenna port for synchronization tracking transmitted with the period of 5 subframes. This is called a CRS for synchronization tracking.

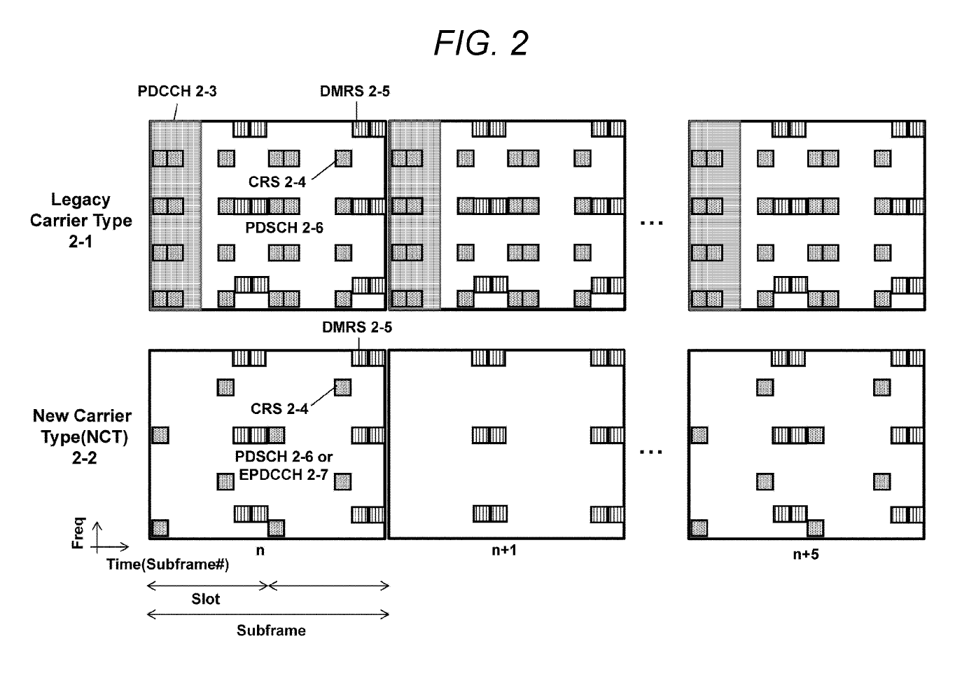

As illustrated in FIG. 2, the CRS for synchronization tracking is transmitted with the period of 5 subframes. However, the terminal cannot recognize which subframe the CRS for synchronization tracking is transmitted with. That is, the terminal cannot recognize whether the CRS for synchronization tracking is transmitted with subframe numbers 0, 5, 10 . . . or 1, 6, 11 . . . , in each cell using the NCT.

A method of specifying that the CRS for synchronization tracking is transmitted with a subframe where the remainder obtained by dividing a subframe number by 5 becomes 0 (subframe number mod 5=0) and sharing information thereof between the terminal and the base station is thought.

However, in this case, transmission timings of the CRSs for synchronization tracking are overlapped between the different cells and the CRSs for synchronization tracking may interfere with each other. Therefore, a subframe offset of the CRS for synchronization tracking may be represented by integer values of 0 to 4 and may be notified to the terminal. The terminal having received the information may assume that the CRS for synchronization tracking is transmitted in a subframe (that is, a subframe becoming subframe number mod 5=the notified subframe offset) where the remainder obtained by dividing the subframe number by 5 is matched with the notified subframe offset. The information may set an independent value for each cell and CC. In addition, the subframe offset may take different values in groups (for example, subbands) of one or more predetermined PRBs.

Alternatively, the subframe offset may be determined implicitly according to a value of the remainder (PCImod 5) obtained by dividing the PCI by 5. That is, the CRS for synchronization tracking may be transmitted in a subframe becoming PCImod 5=subframe number mod 5. Even in this case, different values may be taken in groups (for example, subbands) of one or more predetermined PRBs. For example, the subframe offset may be determined according to a value becoming (PCI+subband number) mod 5. As such, the subframe offset is determined implicitly by the PCI, so that the overlapping probability of the transmission timings of the CRSs for synchronization tracking in adjacent cells can be reduced as compared with the case in which the subframe offset is set to a fixed value. In addition, overhead to transmit the subframe offset can be reduced as compared with the case in which the subframe offset is notified to the terminal.

The information of the subframe which the CRS for synchronization tracking is transmitted with can be transmitted from the base station to the terminal, in Measurement Config to be an RRC configuration to measure RSRP of adjacent cells by the terminal. The macro base station transmits a list of carrier frequencies or PCIs of the adjacent cells using the NCT existing around the macro base station and transmits the subframe offset of the CRS for synchronization tracking, in Measurement Config. However, when the subframe offset of the CRS for synchronization tracking is fixed or is determined implicitly according to the PCI, transmission of the subframe offset may be omitted.

In addition, the information of the adjacent cells using the NCT may be necessary when the terminal before initial access or the terminal of an idle state selects and reselects the cell as well as when the reception power of the NCT is measured. For example, a list of the carrier frequencies or the PCIs of the adjacent cells using the NCT and the subframe offset of the CRS for synchronization tracking is necessary to prevent the terminal from unnecessarily having access to the NCT, when the cells using the NCT cannot perform communication by only the NCT. Alternatively, when the NCT is extended to enable communication by only the NCT, the same information is necessary to enable the terminal to have initial access to the NCT.

This information may be transmitted as system information broadcasted in the cell. For example, the information may be transmitted in SystemInformationBlockType4 transmitting adjacent cell information of the same frequency or SystemInformationBlockType5 transmitting adjacent cell information of a different frequency. Alternatively, new SystemInformationBlockType may be added and a list of the adjacent cells using the NCT may be collected and transmitted for both the same frequency and the different frequency (for example, SystemInformationBlockType17 is added).

A second method of measuring the reception power of the NCT is a method using CSI-RS. The CSI-RS is a reference signal for channel information estimation such as a channel quality indicator (CQI) showing communication quality information, a rank indicator (RI) showing a rank (number of layers) of multiple-input multiple-output (MIMO), a precoding matrix indicator (PMI) showing a precoding matrix of the MIMO preferable for the terminal. The CSI-RS is used to measure channel information of a short period as compared with the reception power (RSRP). However, the CSI-RS can be used for calculating the reception power by averaging in a time direction.

The CSI-RS is configured by resourceConfig showing inserted RE, subframeConfig showing the transmitted period and subframe offset, scramblingIdentity (this corresponds to the PCI) used to determine a signal sequence of the CSI-RS, and antennaPortCount showing the number of the antenna ports. The macro base station may include the parameter for the CSI-RS of the small cell using the NCT existing around the macro base station in MeasurementConfig and may transmit MeasurementConfig to the terminal. In addition, the PCI or the number of antenna ports of the cell transmitting the CRS may be transmitted to show the information of the CRS transmitted from the same position as the position of the CSI-RS. Similar to the CRS for synchronization tracking, this information may be included in SystemInformationBlock and transmitted.

### REFERENCE SIGNS LIST

1-1 macro base station
1-2 macro cell
1-3 small cell base station
1-4 small cell
1-5 terminal

Representative aspects of the invention other than aspects described in claims are as follows.

1. A wireless communication system for performing communication using a plurality of frequency carriers,

wherein, when one frequency carrier is configured as a first cell and one or more frequency carriers are configured as second cells, a base station informs one frequency carrier of the second cells as a frequency carrier transmitting a control channel of an uplink of a physical layer to a terminal by a control signal of an higher layer, and

the terminal transmits the control channel of the uplink of the physical layer, using the informed frequency carrier.

2. The wireless communication system according to 1, wherein overhead of the second cell is smaller than overhead of the first cell by reduction of a reference signal and a control channel of a downlink of the physical layer.

3. The wireless communication system according to 1, wherein the terminal determines transmission power of the control channel of the uplink of the physical layer, using propagation loss of the informed second cell.

4. The wireless communication system according to 1, wherein the terminal generates a signal of the control channel of the uplink of the physical layer, using a cell identifier of a physical layer of the informed second cell.

5. The wireless communication system according to 1, wherein, when the second cell transmitting the control channel of the uplink of the physical layer is informed to the terminal, the base station transmits information to transmit resources of the control channel of the uplink of the physical layer.

6. The wireless communication system according to 1, wherein the terminal transmits partial information of information transmitted by the control channel of the uplink of the physical layer by the frequency carrier of the first cell and transmits the other information by the frequency carrier of the informed second cell.

7. The wireless communication system according to 6, wherein the partial information is ACK information for a data channel of a downlink transmitted by the first cell.

8. The wireless communication system according to 7, wherein the data channel of the downlink transmitted by the first cell is scheduled using a common search space of a control channel of a downlink of the physical layer.

9. The wireless communication system according to 1, wherein, when a frequency carrier transmitting the control channel of the uplink of the physical layer is not informed, the terminal transmits the control channel of the uplink of the physical layer using the frequency carrier of the first cell.

10. The wireless communication system according to 1, wherein the base station configures a frequency carrier transmitting the control channel of the uplink of the physical layer independently, according to information of the control channel of the uplink of the physical layer.

11. The wireless communication system according to 10, wherein the information of the control channel of the uplink of the physical layer is any one of ACK information, channel state information, and a scheduling request.

12. A wireless communication system for performing communication using a plurality of frequency carriers,

wherein one frequency carrier is configured as a first cell and one or more frequency carriers are configured as second cells, and

when a first base station uses the first cell and a second base station uses the second cells, a base station informs a change of a base station transmitting a control channel of an uplink of a physical layer from the first base station to the second base station to a terminal and the terminal transmits the control channel of the uplink of the physical layer to the informed second base station.

13. The wireless communication system according to 12, wherein the base station transmits a cell identifier of the physical layer used to generate a signal sequence of the control channel of the uplink of the physical layer to the terminal.

14. The wireless communication system according to any one of 1 to 13, wherein transmission power of the first cell is larger than transmission power of the second cell.

15. A wireless communication system using a frequency carrier reducing overhead by reducing a reference signal and a control channel of a downlink of a physical layer,

wherein the reference signal used for synchronization tracking of the frequency carrier is transmitted in a subframe in which the remainder obtained by dividing a cell identifier of a physical layer by 5 is equal to the remainder obtained by dividing a subframe number by 5.

1. A wireless communication method of performing communication using a plurality of frequency carriers,
wherein a cell in which a terminal establishes connection is configured as a first cell and a cell other than the first cell is configured as a second cell,
a frequency carrier corresponding to the first cell is configured as a first frequency carrier and a frequency carrier corresponding to the second cell is configured as a second frequency carrier,
a base station transmits information to configure a frequency carrier transmitting information of a control channel of an uplink of a physical layer as the second frequency carrier to the terminal by a control signal of an higher layer, and
the terminal transmits the information of the control channel of the uplink of the physical layer using the second frequency carrier, on the basis of the transmitted information.

2. The wireless communication method according to claim 1, wherein the first frequency carrier is a legacy carrier and the second frequency carrier is a new carrier type.

3. The wireless communication method according to claim 1, wherein the base station transmits an index of the second cell as the information to configure the frequency carrier transmitting the information of the control channel of the uplink of the physical layer as the second frequency carrier to the terminal.

4. The wireless communication method according to claim 1, wherein, when the information to configure the frequency carrier transmitting the information of the control channel of the uplink of the physical layer as the second frequency carrier is not transmitted, the terminal transmits the information of the control channel of the uplink of the physical layer using the first frequency carrier.

5. The wireless communication method according to claim 1, wherein, when the information to configure the frequency carrier transmitting the information of the control channel of the uplink of the physical layer as the second frequency carrier is transmitted, the base station transmits information to determine resources of the control channel of the uplink of the physical layer.

6. The wireless communication method according to claim 1, wherein the terminal generates the information of the control channel of the uplink of the physical layer, using a cell identifier of a physical layer of the configured second cell when a cell is configured as the second cell to the terminal.

7. The wireless communication method according to claim 3, wherein the information of the control channel of the uplink of the physical layer is generated using a cell identifier of a physical layer of the second cell corresponding to the configured index of the second cell.

8. The wireless communication method according to claim 1, wherein the terminal determines transmission power of the control channel of the uplink of the physical layer, using propagation loss of the second cell corresponding to the configured second frequency carrier.

9. The wireless communication method according to claim 1, wherein the terminal transmits first information of the information of the control channel of the uplink of the physical layer using the first frequency carrier and transmits second information using the second frequency carrier.

10. The wireless communication method according to claim 9, wherein the first information is ACK information for a data channel of a downlink transmitted from the base station to the terminal using the first frequency carrier.

11. The wireless communication method according to claim 10, wherein the data channel of the downlink is scheduled using a common search space of the control channel of the downlink of the physical layer.

12. The wireless communication method according to claim 1,
wherein when the information of the control channel of the uplink of the physical layer is a scheduling request of an uplink, the terminal transmits the scheduling request using the first frequency carrier, and
when the information of the control channel of the uplink of the physical layer is channel state information, the terminal transmits the channel state information using the second frequency carrier.

13. A wireless communication system for performing communication using a plurality of frequency carriers,
wherein the wireless communication system has a first base station corresponding to a first cell and a second base station corresponding to a second cell, when a cell in which a terminal establishes connection is configured as the first cell and a cell other than the first cell is configured as the second cell,
the first base station transmits information to change a transmission destination to transmit information of a control channel of an uplink of a physical layer from the first base station to the second base station to the terminal, and
the second base station receives the information of the control channel of the uplink of the physical layer from the terminal.

14. The wireless communication system according to claim 13, wherein the base station configures a cell identifier of the physical layer to generate the information of the control channel of the uplink of the physical layer to the terminal.

15. A wireless communication method of performing communication using a frequency carrier of a new carrier type,
wherein a base station transmits a reference signal for synchronization tracking of the frequency carrier to a terminal, in a subframe in which the remainder obtained by dividing a cell identifier of a physical layer by 5 is equal to the remainder obtained by dividing a subframe number by 5.
